(19) United States
(12) Patent Application Publication
(10) Pub. No.: US 2026/0097686 A1
(43) Pub. Date: Apr. 9, 2026

(54) SYSTEM AND METHOD FOR CONTROLLING AUXILIARY SYSTEM OF WORK MACHINE

(71) Applicant: Caterpillar Inc., Peoria, IL (US)

(72) Inventors: Cameron Thomas Lane, Oro Valley, AZ (US); Karl Schneider, Decatur, IL (US); Andrew John Olson, Vail, AZ (US)

(73) Assignee: Caterpillar Inc., Peoria, IL (US)

(21) Appl. No.: 18/910,021

(22) Filed: Oct. 9, 2024

(51) Int. Cl. B60L 58/14; B60L 1/00

(52) U.S. Cl. CPC B60L 58/14; B60L 1/00

(57) ABSTRACT

A system for controlling an auxiliary system of a work machine. The auxiliary system receives an operating power supply from a battery system of the work machine. The system includes a controller including at least one memory and at least one processor in communication with the at least one memory. The at least one processor is configured to determine if the work machine is in an idle state. The at least one processor is also configured to operate, upon determining that the work machine is in the idle state, the auxiliary system of the work machine in an off-state or in a predetermined operating range to reduce power draw by the auxiliary system from the battery system. The auxiliary system includes a thermal management system, a power management system, a traction system, a hydraulic system, and/or a steering system.

### TECHNICAL FIELD

The present disclosure relates to a work machine, and more particularly, to a system and a method for controlling an auxiliary system of the work machine.

### BACKGROUND

An electric powered work machine, such as an electric mining truck, includes a battery system that supplies electric power to one or more auxiliary systems of the work machine in order to perform work operations at a worksite. Such auxiliary systems include parasitic components that receive electrical power from the battery system for operation.

During a working cycle of the electric powered work machine, there are instances wherein the work machine is in an idle state and not actively performing work operations. In such instances, the auxiliary systems operate in an active state, in order to maintain the work machine in a ready-to-work state. Thus, in such instances, the auxiliary systems constantly consume electrical power without a productivity benefit, thereby resulting in wastage of the electrical power. Moreover, operation of the auxiliary systems when the work machine is in the idle state consumes a finite amount of electrical energy that is present onboard, and may also result in increase in machine component wear, increase in a charging frequency of the work machine, as well as increase in a downtime of the work machine. Therefore, it may be desirable to keep the work machine in the ready-to-work state with minimal parasitic loss.

CN106455022A describes a power saving mode switching method and device. The method comprises the steps of: detecting a CPU (Central Processing Unit) load and/or network traffic of a terminal; determining whether a system is in an idle state according to the CPU load and/or network traffic of the terminal; when the system is detected to be in the idle state, detecting the duration of the system in the idle state; when the detected duration is greater than or equal to a preset time length threshold, acquiring a system configuration file; and configuring parameters entering a power saving mode in the system configuration file, so that the system enters the power saving mode. The method and the device can improve the convenience of operation when the power saving mode of the mobile terminal is switched.

### SUMMARY OF THE DISCLOSURE

In an aspect of the present disclosure, a system for controlling an auxiliary system of a work machine is provided. The auxiliary system receives an operating power supply from a battery system of the work machine. The system includes a controller including at least one memory and at least one processor in communication with the at least one memory. The at least one processor is configured to determine if the work machine is in an idle state. The at least one processor is also configured to operate, upon determining that the work machine is in the idle state, the auxiliary system of the work machine in an off-state or in a predetermined operating range to reduce power draw by the auxiliary system from the battery system. The auxiliary system includes a thermal management system, a power management system, a traction system, a hydraulic system, and/or a steering system.

In another aspect of the present disclosure, a work machine is provided. The work machine includes a battery system. The work machine also includes an auxiliary system that operates based on receipt of an operating power supply from the battery system. The auxiliary system includes a thermal management system, a power management system, a traction system, a hydraulic system, and/or a steering system. The work machine further includes a system for controlling the auxiliary system of the work machine. The system includes a controller including at least one memory and at least one processor in communication with the at least one memory. The at least one processor is configured to determine if the work machine is in an idle state. The at least one processor is also configured to operate, upon determining that the work machine is in the idle state, the auxiliary system of the work machine in an off-state or in a predetermined operating range to reduce power draw by the auxiliary system from the battery system.

In yet another aspect of the present disclosure, a method for controlling an auxiliary system of a work machine is provided. The auxiliary system receives an operating power supply from a battery system of the work machine. The method includes determining, by at least one processor of a controller, if the work machine is in an idle state. The method also includes operating, by the at least one processor, the auxiliary system of the work machine in an off-state or in a predetermined operating range to reduce power draw by the auxiliary system from the battery system upon determining that the work machine is in the idle state. The auxiliary system includes a thermal management system, a power management system, a traction system, a hydraulic system, and/or a steering system.

Other features and aspects of this disclosure will be apparent from the following description and the accompanying drawings.

### BRIEF DESCRIPTION OF THE DRAWINGS

FIG. 1 is a schematic side view of an exemplary work machine;

FIG. 2 is a schematic block diagram of a system for controlling an auxiliary system of the work machine of FIG. 1, according to an example of the present disclosure;

FIG. 3 is a flowchart of a method for controlling the auxiliary system of the work machine of FIG. 1, according to an example of the present disclosure.

### DETAILED DESCRIPTION

Wherever possible, the same reference numbers will be used throughout the drawings to refer to the same or like parts.

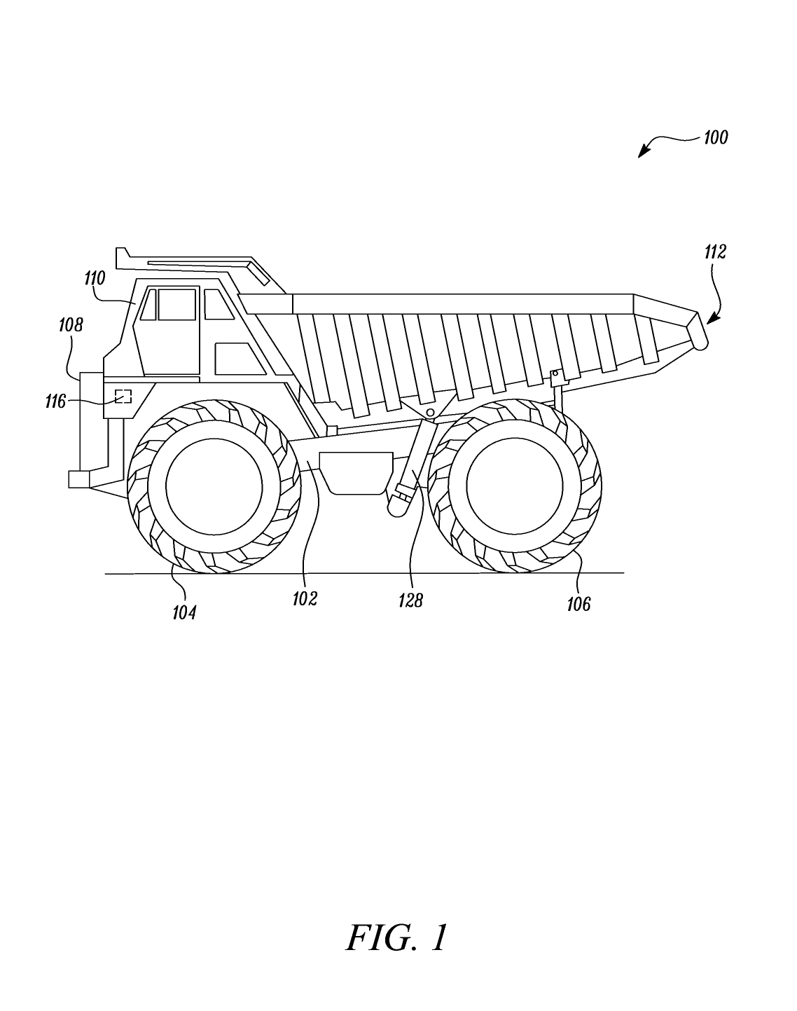

Referring to FIG. 1, a schematic side view of a work machine 100 is illustrated. The work machine 100 is embodied as a mining truck that may be used to move payload, such as, asphalt, debris, dirt, snow, feed, gravel, logs, raw minerals, recycled material, rock, sand, woodchips, etc. from one location to another location. Alternatively, the work machine 100 may be a hydraulic excavator, a dozer, a wheel loader, a track-type tractor, a motor grader, etc. that may be used for various purposes, such as, digging, construction, landscaping, and the like in various industries. It should be noted that the work machine 100 may include any other stationary or movable work machine known in the art. The work machine 100 may be manual, autonomous, or semi-autonomous.

The work machine 100 includes a frame 102. The frame 102 supports a pair of front wheels 104 and a pair of rear wheels 106 of the work machine 100. The work machine 100 also includes an enclosure 108 and an operator cabin 110 mounted to the frame 102. The work machine 100 further includes a battery system 116. The enclosure 108 may house the battery system 116. The battery system 116 provides power to various components of the work machine 100 for operational and mobility requirements. The operator cabin 110 may include one or more controls (not shown) that may enable an operator to control the work machine 100. The operator may be seated within the operator cabin 110 to perform work operations.

The work machine 100 further includes a dump body 112 to hold the payload therein. The dump body 112 is movable relative to the frame 102. Further, when the work machine 100 is of another type, such as, the track type tractor, the excavator, the bulldozer, the motor grader, the work machine 100 includes one or more implement assemblies instead of the dump body 112. Such implement assemblies may include an implement, such as a bucket, blade, ripper, one or more linkages, and one or more hydraulic actuators to move the implement and the linkages.

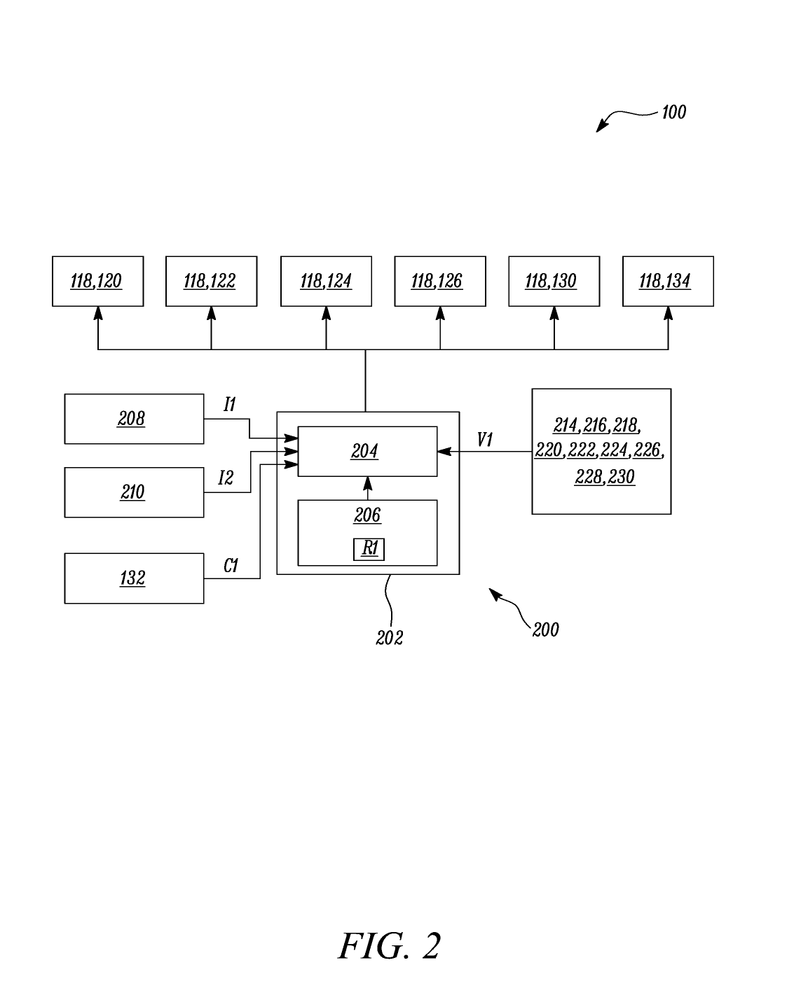

The work machine 100 includes an auxiliary system 118 (see FIG. 2) that receives an operating power supply from the battery system 116 of the work machine 100. The auxiliary system 118 operates based on receipt of the operating power supply from the battery system 116. The auxiliary system 118 includes a thermal management system 120 (see FIG. 2), a power management system 122 (see FIG. 2), a traction system 124 (see FIG. 2), a hydraulic system 126 (see FIG. 2) and/or a steering system 130 (see FIG. 2). The work machine 100 of the present disclosure includes each of the thermal management system 120, the power management system 122, the traction system 124, the hydraulic system 126, and the steering system 130. The auxiliary system 118 may also include a braking system 134 (see FIG. 2). It should be noted that the work machine 100 may include multiple auxiliary systems in order to realize various operations via the work machine 100. The present disclosure is not limited by a type of the auxiliary systems associated with the work machine 100 or a number of the auxiliary systems associated with the work machine 100.

In some examples, the traction system 124 may include one or more traction motors that receives the electrical energy from the battery system 116 to provide necessary torque to propel the work machine 100. The traction motors are operatively coupled to the wheels 104, 106 of the work machine 100. The traction system 124 may facilitate adjustment in a speed of the traction motors to provide necessary torque to propel the work machine 100. In some examples, the steering system 130 may include components that allow steering of the work machine 100 while the work machine 100 is moving from one place to another.

In some examples, the thermal management system 120 may include one or more motors, one or more pumps, one or more blowers, and the like. The thermal management system 120 may be used to maintain a temperature of various components of the work machine 100 within an acceptable range. In an example, the thermal management system 120 may be used to maintain a temperature of the battery system 116, a temperature of the operator cabin 110, a temperature of the power management system 122, a temperature of power electronic components of the work machine 100, a temperature of the components of the hydraulic system 126, such as, cooling of hydraulic oil used in the hydraulic system 126, a temperature of the components of the traction system 124, such as cooling of the traction motors, a temperature of the braking system 134 of the work machine 100, and the like.

It should be noted that the thermal management system 120 may allow control of heating setpoints, cooling setpoints, speed and orientation of the blowers, speed of the pumps, speed of the motors, pressures at an outlet of the pumps, and the like to facilitate an operation of the machine components linked with the thermal management system 120 in a desired manner.

In some examples, the power management system 122 may include one or more converters, one or more voltage conversion devices, one or more inverters, one or more on-board chargers (OBC), and the like that may allow conversion of electric power to operate the machine components of the work machine 100, as per their configuration. The power management system 122 may supply/distribute the operating power from the battery system 116 to various machine components of the work machine 100.

In some examples, the hydraulic system 126 may include one or more hydraulic pumps, one or more hydraulic motors, one or more hydraulic actuators 128 (one of which is shown in FIG. 1), a lubrication system for a gearbox of the work machine 100, one or more accumulators, and the like that may assist the work machine 100 to perform one or more work operations. It should be noted that a speed of the hydraulic pumps, a speed of the hydraulic motors, pressures at an outlet of the hydraulic pumps, and the like may be controlled to facilitate an operation of the machine components linked with the hydraulic system in a desired manner.

The hydraulic system 126 may operate in conjunction with the braking system 134, the steering system 130, the implement assembly of the work machine 100, the dump body 112, the traction system 124, and the like. For example, the hydraulic system 126 may control the hydraulic actuators 128 to cause the dump body 112 to move relative to the frame 102 in order to perform a dumping operation.

Referring to FIG. 2, a schematic block diagram of a system 200 for controlling the auxiliary system 118 of the work machine 100 of FIG. 1 is illustrated. Particularly, the work machine 100 includes the system 200. The system 200 includes a controller 202 including one or more memories 206 and one or more processors 204 in communication with the one or more memories 206.

The one or more memories 206 may include any means of storing information, including a hard disk, an optical disk, a floppy disk, ROM (read only memory), RAM (random access memory), PROM (programmable ROM), EEPROM (electrically erasable PROM), or other computer-readable memory media.

It should be noted that the one or more processors 204 may embody a single microprocessor or multiple microprocessors for receiving various input signals and generating output signals. Numerous commercially available microprocessors may perform the functions of the processors 204. The one or more processors 204 may further include a general processor, a central processing unit, an application specific integrated circuit (ASIC), a digital signal processor, a field programmable gate array (FPGA), a digital circuit, an analog circuit, a microcontroller, any other type of processor, or any combination thereof. The one or more processors 204 may include one or more components that may be operable to execute computer executable instructions or computer code that may be stored and retrieved from the one or more memories 206.

The one or more processors 204 determine if the work machine 100 is in an idle state. In an example, the one or more processors 204 determine that the work machine 100 is in the idle state based on an operator input I1 received via an input device 208 of the work machine 100. The input device 208 includes a throttle pedal, a primary brake pedal, a secondary brake pedal, a braking lever, and/or a shift lever. The input device 208 is disposed in the operator cabin 110 (see FIG. 1). For example, if the operator operates the braking lever, the operator input I1 may be sent to the processors 204. Based on the receipt of the operator input I1, the processors 204 may determine that the work machine 100 is stationary and is therefore in the idle state. In some examples, the processors 204 may also check a time period for which the work machine 100 is in the stationary state to determine if the work machine 100 is in the idle state. In some examples, the processors 204 may be able to determine that the work machine 100 is in the idle state based on an absence of the operator from the work machine 100. In some examples, the system 200 may include one or more additional sensors to determine that the operator is not present in the operator cabin 110. The additional sensors may include, for example, a seat belt sensor, a seat weight sensor, a door open/close sensor, a sensor position for position of an access system (stored or deployed), and the like.

In another example, the one or more processors 204 determine that the work machine 100 is in the idle state based on an input signal I2 received from a fleet management system 210 associated with the work machine 100 and/or a current configuration C1 of the work machine 100. The fleet management system 210 may provide information related to various work machines (not shown) operating at a worksite (not shown). The fleet management system 210 may be used for asset management and for providing an interface for controlling or accessing information related to an operation of a fleet of the work machines, including the work machine 100. The fleet management system 210 may identify location and direction of movement of each work machine in the fleet in real-time and a status of predetermined events/work operations in which each work machine is engaged. For example, the one or more processors 204 may determine that the work machine 100 is in the idle state based on a position/ location of the work machine 100 relative to other site operations, a queue time for the work machine 100, work operations assigned to the work machine 100, a start time and/or an end time of the work operations assigned to the work machine 100, etc.

The current configuration C1 of the work machine 100 may include, for example, the stationary state of the work machine 100, an idle time of the work machine 100, and the like. For example, if the work machine 100 is of the autonomous or semi-autonomous type, a work plan may be prestored in a control system 132 associated with the work machine 100. The control system 132 may include, for example, an onboard machine controller. The processors 204 may be in communication with the control system 132 to determine the idle state of the work machine 100 based on the prestored work plan. The processors 204 may receive the current configuration C1 of the work machine 100 from the control system 132.

It should be noted that the present disclosure is not limited by a technique that is used to determine the idle state of the work machine 100. Any other technique and/or sensing devices may be used to determine the idle state of the work machine 100.

The one or more processors 204 operate, upon determining that the work machine 100 is in the idle state, the auxiliary system 118 of the work machine 100 in an off-state or in a predetermined operating range to reduce power draw by the auxiliary system 118 from the battery system 116 (see FIG. 1). The term “predetermined operating range” as used herein includes an operating range for various components of the auxiliary system 118 that may reduce power consumption by the auxiliary system 118 while maintaining the auxiliary system 118 in an operating state. In some examples, operating one or more components of the auxiliary system 118 in the predetermined operating range may cause the one or more components to be operated at a lower speed so as to reduce power draw from the battery system 116.

In some examples, when the auxiliary system 118 includes the thermal management system 120 or the power management system 122, the one or more processors 204 operate the auxiliary system 118 of the work machine 100 in the predetermined operating range. Further, in some examples, when the auxiliary system 118 includes the traction system 124, the hydraulic system 126, or the steering system, 130 the one or more processors 204 operate the auxiliary system 118 of the work machine 100 in the off-state.

The auxiliary system 118 of the work machine 100 is operated in the off-state or in the predetermined operating range based on a recovery time of the auxiliary system 118. In an example, if the recovery time of the auxiliary system 118 is longer, the auxiliary system 118 of the work machine 100 is operated in the predetermined operating range. For example, the recovery time of the thermal management system 120 is generally higher as it might take some time to achieve a desired temperature value. Moreover, if the thermal management system 120 is kept off when the work machine 100 is in a key-ON state, there may be a possibility of overheating of one or more machine components. Thus, the thermal management system 120 may be operated in the predetermined operating range to allow a full capability of the thermal management system 120 to be maintained without excessive power consumption of the electric power supply, when the work machine 100 is in the idle state. As an example, when the thermal management system 120 is used to maintain the temperature of the battery system 116, if a desired temperature range for the battery system 116 is between 15º C and 25º C, then the processors 204 may cause the thermal management system 120 to operate in the predetermined operating range so that a temperature range for the battery system 116 is maintained between 20º C and 25º C i.e., at a higher side, to reduce power consumption by the thermal management system 120 while still providing cooling.

In another example, if the recovery time of the auxiliary system 118 is shorter, the auxiliary system 118 of the work machine 100 is operated in the off-state. For example, the recovery time of the traction motors of the traction system 124 is generally shorter as the traction motor may regain full operating capability in a short time to achieve a desired speed value for the work machine 100. Thus, the traction system 124 may be operated in the off-state to reduce power consumption by the traction system 124, when the work machine 100 is in the idle state. Moreover, the hydraulic system 126 includes accumulators associated therewith. Thus, some components of the hydraulic system 126 may be turned off as they may regain full capability in a shorter time as the accumulators maintain a charge.

In some examples, the system 200 further includes one or more sensors 214, 216, 218, 220, 222, 224, 226, 228, 230 associated with the one or more machine components of the work machine 100. The one or more machine components may include, for example, the battery system 116, the operator cabin 110 (see FIG. 1), the wheels 104, 106 (see FIG. 1), the components of the auxiliary system 118, and the like. The current operating value V1 may include a temperature value, a speed value, a pressure value, and the like.

The one or more sensors 214, 216, 218, 220, 222, 224, 226, 228, 230 includes an accumulator pressure sensor 214, a battery cell temperature sensor 216, a power electronic component temperature sensor 218, a traction motor temperature sensor 220, an operator cab temperature sensor 222, a hydraulic temperature sensor 224, a braking system temperature sensor 226, an ambient temperature sensor 228, and/or a wheel speed sensor 230.

The accumulator pressure sensor 214 may generate a signal indicative of a pressure in the accumulators of the hydraulic system 126. The battery cell temperature sensor 216 may generate a signal indicative of a temperature of battery cells of the battery system 116. The power electronic component temperature sensor 218 may generate a signal indicative of a temperature of the components of the power management system 122. The traction motor temperature sensor 220 may generate a signal indicative of the traction motor of the traction system 124. The operator cab temperature sensor 222 may generate a signal indicative of a temperature within the operator cabin 110. The hydraulic temperature sensor 224 may generate a signal indicative of a temperature of one or more components of the hydraulic system 126, including, hydraulic oil temperature. The braking system temperature sensor 226 may generate a signal indicative of a temperature of one or more components of the braking system 134. The ambient temperature sensor 228 may generate a signal indicative of ambient temperature. The wheel speed sensor 230 may generate a signal indicative of a speed of the wheels 104, 106 of the work machine 100. It should be noted that the one or more sensors 214, 216, 218, 220, 222, 224, 226, 228, 230 may include any other sensor apart from those mentioned herein.

The one or more sensors 214, 216, 218, 220, 222, 224, 226, 228, 230 are in communication with the one or more processors 204. The one or more processors 204 receive a current operating value V1 of the one or more machine components from the one or more sensors 214, 216, 218, 220, 222, 224, 226, 228, 230.

The one or more processors 204 compare the current operating value V1 with a desired operating range R1 for the one or more machine components. The desired operating range R1 is prestored in the one or more memories 206. The one or more processors 204 operate the auxiliary system 118 of the work machine 100 in the off-state or in the predetermined operating range, based on the comparison between the current operating value V1 and the desired operating range R1. Specifically, based on the comparison between the current operating value V1 and the desired operating range R1, the processors 204 may determine which auxiliary system 118 may be operated in the off-state or in the predetermined operating range. In some examples, the desired operating range R1 may be same as the predetermined operating range. However, it may be contemplated that the desired operating range R1 may be different from the predetermined operating range, for example, the desired operating range R1 may be greater in value than the predetermined operating range.

In an example, for the thermal management system 120, if the current operating value V1 (i.e., a current temperature value) of the battery system 116 is at a lower end of the desired operating range R1, the processors 204 may control the thermal management system 120 so that the current temperature value of the battery system 116 is at a higher end of the desired operating range R1, but is still maintained within the desired operating range R1. This way, the thermal management system 120 may consume less operating power while maintaining the battery system 116 in the desired operating range R1. Similarly, the comparison between the current operating value V1 and the desired operating range R1 may allow the processors 204 to control the power management system 122, the traction system 124, the hydraulic system 126, and/or the steering system 130 so that they consume less operating power, while maintaining the one or more machine components in the desired operating range R1.

It is to be understood that individual features shown or described for one embodiment may be combined with individual features shown or described for another embodiment. The above described implementation does not in any way limit the scope of the present disclosure. Therefore, it is to be understood although some features are shown or described to illustrate the use of the present disclosure in the context of functional segments, such features may be omitted from the scope of the present disclosure without departing from the spirit of the present disclosure as defined in the appended claims.

### INDUSTRIAL APPLICABILITY

The present disclosure relates to the system 200 for controlling the auxiliary system 118 of the work machine 100. The auxiliary system 118 includes the thermal management system 120, the power management system 122, the traction system 124, the hydraulic system 126, and/or the steering system 130. The system 200 adjusts the operating power supply from the battery system 116 to the auxiliary system 118 such that the auxiliary system 118 may operate in the off-state or in the predetermined operating range. In other words, the system 200 may allow the auxiliary system 118 to consume less or minimal power when the work machine 100 is in the idle state. Further, the system 200 may allow the auxiliary system 118 to quickly resume its full capability when the work machine 100 is not in the idle state.

Further, as the system 200 operates the auxiliary system 118 in the off-state or in the predetermined operating range when the work machine 100 is in the idle state, the system 200 may reduce wear of components such as fan, motors, pumps, etc., may reduce a charging frequency of the work machine 100, and may reduce a downtime of the work machine 100.

Overall, the system 200 is simple in operation, and may simplify a working of the work machine 100, may reduce maintenance/replacement costs of the work machine 100, and may improve an efficiency of the work machine 100.

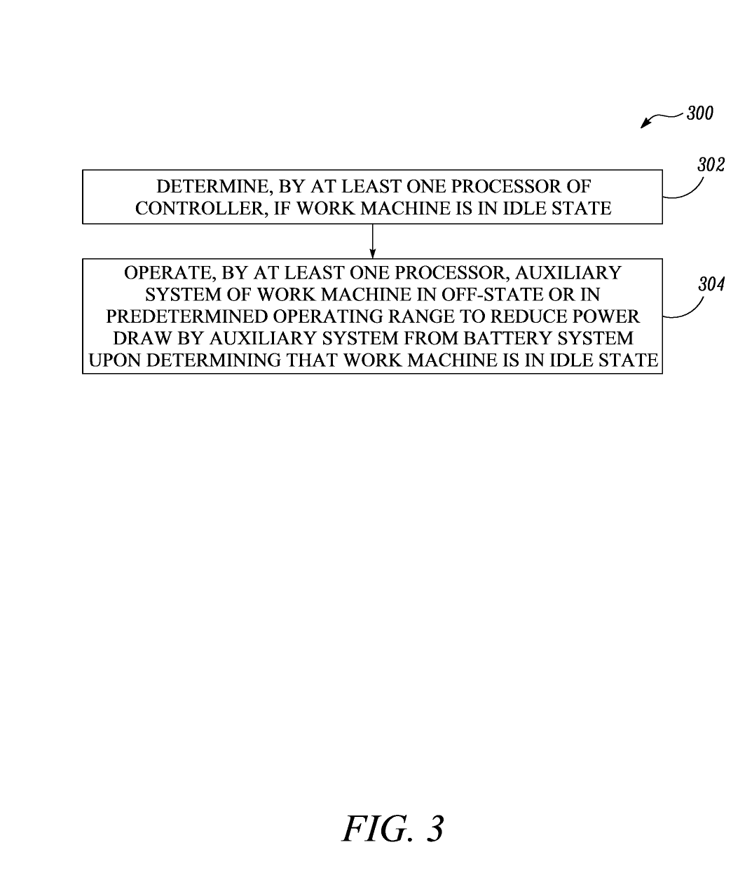

FIG. 3 is a flowchart of a method 300 for controlling the auxiliary system 118 of the work machine 100. With reference to FIGS. 1 to 3, the auxiliary system 118 receives the operating power supply from the battery system 116 of the work machine 100. At step 302, the one or more processors 204 of the controller 202 determine if the work machine 100 is in the idle state.

The method 300 also includes a step at which the one or more processors 204 receive the operator input I1 via the input device 208 of the work machine 100, the input signal I2 from the fleet management system 210 associated with the work machine 100, and/or the current configuration C1 of the work machine 100 to determine if the work machine 100 is in the idle state. The input device 208 includes the throttle pedal, the primary brake pedal, the secondary brake pedal, the braking lever, and/or the shift lever.

At step 304, the one or more processors 204 operate the auxiliary system 118 of the work machine 100 in the off-state or in the predetermined operating range to reduce power draw by the auxiliary system 118 from the battery system 116 upon determining that the work machine 100 is in the idle state. The auxiliary system 118 includes the thermal management system 120, the power management system 122, the traction system 124, the hydraulic system 126, and/or the steering system 130.

The auxiliary system 118 of the work machine 100 is operated in the off-state or in the predetermined operating range based on the recovery time of the auxiliary system 118.

The method 300 includes a step at which the one or more processors 204 receives the current operating value V1 of the one or more machine components of the work machine 100 from one or more sensors 214, 216, 218, 220, 222, 224, 226, 228, 230 associated with the one or more machine components. The one or more sensors 214, 216, 218, 220, 222, 224, 226, 228, 230 is in communication with the one or more processors 204. The one or more sensors 214, 216, 218, 220, 222, 224, 226, 228, 230 includes the accumulator pressure sensor 214, the battery cell temperature sensor 216, the power electronic component temperature sensor 218, the traction motor temperature sensor 220, the operator cab temperature sensor 222, the hydraulic temperature sensor 224, the braking system temperature sensor 226, the ambient temperature sensor 228, and/or the wheel speed sensor 230.

The method 300 further also a step at which the one or more processors 204 compare the current operating value V1 with the desired operating range R1 for the one or more machine components. The desired operating range R1 is prestored in the one or more memories 206 of the controller 202. The one or more memories 206 are in communication with the one or more processors 204. The method 300 further includes a step at which the one or more processors 204 operate the auxiliary system 118 of the work machine 100 in the off-state or in the predetermined operating range, based on the comparison between the current operating value V1 and the desired operating range R1.

It should be noted that one or more steps of the method 300 may be performed in a manner different from that illustrated and explained in relation to FIG. 3. Further, various steps may be performed together.

While aspects of the present disclosure have been particularly shown and described with reference to the embodiments above, it will be understood by those skilled in the art that various additional embodiments may be contemplated by the modification of the disclosed work machine, systems and methods without departing from the spirit and scope of the disclosure. Such embodiments should be understood to fall within the scope of the present disclosure as determined based upon the claims and any equivalents thereof.

What is claimed is:

1. A system for controlling an auxiliary system of a work machine, wherein the auxiliary system receives an operating power supply from a battery system of the work machine, the system comprising:
a controller including at least one memory and at least one processor in communication with the at least one memory, the at least one processor is configured to:
determine if the work machine is in an idle state; and
operate, upon determining that the work machine is in the idle state, the auxiliary system of the work machine in an off-state or in a predetermined operating range to reduce power draw by the auxiliary system from the battery system, wherein the auxiliary system includes a thermal management system, a power management system, a traction system, a hydraulic system, and/or a steering system.

2. The system of claim 1, wherein the auxiliary system of the work machine is operated in the off-state or in the predetermined operating range based on a recovery time of the auxiliary system.

3. The system of claim 1, wherein, when the auxiliary system includes the thermal management system or the power management system, the at least one processor is configured to operate the auxiliary system of the work machine in the predetermined operating range, and wherein, when the auxiliary system includes the traction system, the hydraulic system, or the steering system, the at least one processor is configured to operate the auxiliary system of the work machine in the off-state.

4. The system of claim 1, wherein the at least one processor is configured to determine that the work machine is in the idle state based on an operator input received via an input device of the work machine, an input signal received from a fleet management system associated with the work machine, and/or a current configuration of the work machine.

5. The system of claim 4, wherein the input device includes a throttle pedal, a primary brake pedal, a secondary brake pedal, a braking lever, and/or a shift lever.

6. The system of claim 1 further comprising at least one sensor associated with one or more machine components of the work machine, wherein the at least one sensor is in communication with the at least one processor, and wherein the at least one processor is configured to:
receive a current operating value of the one or more machine components from the at least one sensor;
compare the current operating value with a desired operating range for the one or more machine components, wherein the desired operating range is prestored in the at least one memory; and
operate the auxiliary system of the work machine in the off-state or in the predetermined operating range, based on the comparison between the current operating value and the desired operating range.

7. The system of claim 6, wherein the at least one sensor includes an accumulator pressure sensor, a battery cell temperature sensor, a power electronic component temperature sensor, a traction motor temperature sensor, an operator cab temperature sensor, a hydraulic temperature sensor, a braking system temperature sensor, an ambient temperature sensor, and/or a wheel speed sensor.

8. A work machine comprising:
a battery system;
an auxiliary system that operates based on receipt of an operating power supply from the battery system, wherein the auxiliary system includes a thermal management system, a power management system, a traction system, a hydraulic system, and/or a steering system; and
a system for controlling the auxiliary system of the work machine, the system including:
a controller including at least one memory and at least one processor in communication with the at least one memory, the at least one processor is configured to:
determine if the work machine is in an idle state; and
operate, upon determining that the work machine is in the idle state, the auxiliary system of the work machine in an off-state or in a predetermined operating range to reduce power draw by the auxiliary system from the battery system.

9. The work machine of claim 8, wherein the auxiliary system of the work machine is operated in the off-state or in the predetermined operating range based on a recovery time of the auxiliary system.

10. The work machine of claim 8, wherein, when the auxiliary system includes the thermal management system or the power management system, the at least one processor is configured to operate the auxiliary system of the work machine in the predetermined operating range, and wherein, when the auxiliary system includes the traction system, the hydraulic system, or the steering system, the at least one processor is configured to operate the auxiliary system of the work machine in the off-state.

11. The work machine of claim 8, wherein the at least one processor is configured to determine that the work machine is in the idle state based on an operator input received via an input device of the work machine, an input signal received from a fleet management system associated with the work machine, and/or a current configuration of the work machine.

12. The work machine of claim 11, wherein the input device includes a throttle pedal, a primary brake pedal, a secondary brake pedal, a braking lever, and/or a shift lever.

13. The work machine of claim 8, wherein the system further includes at least one sensor associated with one or more machine components of the work machine, wherein the at least one sensor is in communication with the at least one processor, and wherein the at least one processor is configured to:
receive a current operating value of the one or more machine components from the at least one sensor;
compare the current operating value with a desired operating range for the one or more machine components, wherein the desired operating range is prestored in the at least one memory; and
operate the auxiliary system of the work machine in the off-state or in the predetermined operating range, based on the comparison between the current operating value and the desired operating range.

14. The work machine of claim 13, wherein the at least one sensor includes an accumulator pressure sensor, a battery cell temperature sensor, a power electronic component temperature sensor, a traction motor temperature sensor, an operator cab temperature sensor, a hydraulic temperature sensor, a braking system temperature sensor, an ambient temperature sensor, and/or a wheel speed sensor.

15. A method for controlling an auxiliary system of a work machine, wherein the auxiliary system receives an operating power supply from a battery system of the work machine, the method comprising:
determining, by at least one processor of a controller, if the work machine is in an idle state; and
operating, by the at least one processor, the auxiliary system of the work machine in an off-state or in a predetermined operating range to reduce power draw by the auxiliary system from the battery system upon determining that the work machine is in the idle state, wherein the auxiliary system includes a thermal management system, a power management system, a traction system, a hydraulic system, and/or a steering system.

16. The method of claim 15, wherein the auxiliary system of the work machine is operated in the off-state or in the predetermined operating range based on a recovery time of the auxiliary system.

17. The method of claim 15 further comprising receiving, by the at least one processor, an operator input via an input device of the work machine, an input signal from a fleet management system associated with the work machine, and/or a current configuration of the work machine to determine if the work machine is in the idle state.

18. The method of claim 17, wherein the input device includes a throttle pedal, a primary brake pedal, a secondary brake pedal, a braking lever, and/or a shift lever.

19. The method of claim 15 further comprising:
receiving, by the at least one processor, a current operating value of one or more machine components of the work machine from at least one sensor associated with the one or more machine components, wherein the at least one sensor is in communication with the at least one processor;
comparing, by the at least one processor, the current operating value with a desired operating range for the one or more machine components, wherein the desired operating range is prestored in at least one memory of the controller, and wherein the at least one memory is in communication with the at least one processor; and
operating, by the at least one processor, the auxiliary system of the work machine in the off-state or in the predetermined operating range, based on the comparison between the current operating value and the desired operating range.

20. The method of claim 19, wherein the at least one sensor includes an accumulator pressure sensor, a battery cell temperature sensor, a power electronic component temperature sensor, a traction motor temperature sensor, an operator cab temperature sensor, a hydraulic temperature sensor, a braking system temperature sensor, an ambient temperature sensor, and/or a wheel speed sensor.
